(19) United States
(12) Patent Application Publication
(10) Pub. No.: US 2026/0359540 A1
(43) Pub. Date: Nov. 12, 2026

(54) SIMULATION METHOD, INFORMATION PROCESSING DEVICE, AND INFORMATION PROCESSING PROGRAM

(71) Applicant: SONY SEMICONDUCTOR SOLUTIONS CORPORATION, KANAGAWA (JP)

(72) Inventor: YASUHIRO OCHIAI, KANAGAWA (JP)

(21) Appl. No.: 19/125,352

(22) PCT Filed: Oct. 12, 2023
(86) PCT No.: PCT/JP2023/036944

§ 371 Date: Apr. 29, 2025

(30) Foreign Application Priority Data
Nov. 4, 2022 (JP) 2022-177071

(51) Int. Cl. G06F 30/367; G06F 119/08

(52) U.S. Cl. CPC G06F 30/367; G06F 2119/08

(57) ABSTRACT

A simulation method includes simulating an in-chip heat distribution of each of a plurality of collectively arranged chips, each of which includes an active element, in consideration of power consumption during an operation of the plurality of chips, simulating an in-chip stress distribution of each of the plurality of chips on the basis of a heat distribution simulation result, and reflecting a stress distribution simulation result in a circuit simulation of each of the plurality of chips.

### FIELD

The present disclosure relates to a simulation method, an information processing device, and an information processing program.

### BACKGROUND

With respect to a circuit simulation of a chip such as a semiconductor chip, for example, Patent Literature 1 discloses a technology of adjusting a parameter of a MOSFET in the circuit simulation on the basis of stress generated due to a size and a peripheral structure of the MOSFET in the chip.

### CITATION LIST

### Patent Literature

Patent Literature 1: Japanese Patent Application Laid-Open No. 2011-150607

### SUMMARY

### Technical Problem

For device integration, a plurality of chips may be collectively arranged on a substrate or package. Stress is generated due to heat generated by a chip operation. Patent Literature 1 does not consider an influence of such stress.

One aspect of the present disclosure makes it possible to reflect an influence of stress generated due to heat generation by a chip operation in a circuit simulation.

### Solution to Problem

A simulation method according to one aspect of the present disclosure includes: simulating an in-chip heat distribution of each of a plurality of collectively arranged chips, each of which includes an active element, in consideration of power consumption during an operation of the plurality of chips; simulating an in-chip stress distribution of each of the plurality of chips on a basis of a heat distribution simulation result; and reflecting a stress distribution simulation result in a circuit simulation of each of the plurality of chips.

An information processing device according to one aspect of the present disclosure includes: a processing unit that simulates an in-chip heat distribution of each of a plurality of collectively arranged chips in consideration of power consumption during an operation of the plurality of chips, simulates an in-chip stress distribution of each of the plurality of chips on a basis of a heat distribution simulation result, and reflects a stress distribution simulation result in a circuit simulation of each of the plurality of chips.

An information processing program according to one aspect of the present disclosure causes a computer to execute processing of: simulating an in-chip heat distribution of each of a plurality of collectively arranged chips in consideration of power consumption during an operation of the plurality of chips; simulating an in-chip stress distribution of each of the plurality of chips on a basis of a heat distribution simulation result; and reflecting a stress distribution simulation result in a circuit simulation of each of the plurality of chips.

### BRIEF DESCRIPTION OF DRAWINGS

FIG. 1 is a view illustrating an example of a model.

FIG. 2 is a view illustrating an example of a heat distribution simulation result.

FIG. 3 is a view illustrating an example of a chip structure.

FIG. 4 is a view illustrating an example of a stress distribution simulation result.

FIG. 5 is a view illustrating an example of stress distribution association.

FIG. 6 is a view illustrating the example of the stress distribution association.

FIG. 7 is a view illustrating an example of heat distribution association.

FIG. 8 is a view illustrating the example of the heat distribution association.

FIG. 9 is a view illustrating an example of a characteristic variation of a MOSFET.

FIG. 10 is a view illustrating an example of the characteristic variation of the MOSFET.

FIG. 11 is a view illustrating an example of the characteristic variation of the MOSFET.

FIG. 12 is a view illustrating an example of the characteristic variation of the MOSFET.

FIG. 13 is a view illustrating an example of a size and a peripheral structure of an active element.

FIG. 14 is a view illustrating an example of a fitting parameter.

FIG. 15 is a view illustrating an example of reflection of a temperature distribution simulation result in a circuit simulation.

FIG. 16 is a view illustrating the example of the reflection of the temperature distribution simulation result in the circuit simulation.

FIG. 17 is a view illustrating an example of reflection of the stress distribution simulation result in the circuit simulation.

FIG. 18 is a view illustrating the example of the reflection of the stress distribution simulation result in the circuit simulation.

FIG. 19 is a flowchart illustrating an example of a flow of a simulation method.

FIG. 20 is a view illustrating an example of a chip arrangement.

FIG. 21 is a view illustrating an example of a chip arrangement.

FIG. 22 is a view illustrating an example of the chip arrangement.

FIG. 23 is a view illustrating an example of the active element.

FIG. 24 is a view illustrating an example of a schematic configuration of an information processing device.

FIG. 25 is a view illustrating a hardware configuration example of the information processing device.

### DESCRIPTION OF EMBODIMENTS

In the following, embodiments of the present disclosure will be described in detail with reference to the drawings. Note that in each of the following embodiments, overlapped description is omitted by assignment of the same reference sign to the same elements.

The present disclosure will be described in the following order of items.
0. Introduction
1. Embodiment
2. Modification example
3. Examples of effects

### 0. Introduction

For example, a plurality of chips may be mounted on a substrate or a package for device integration. There are various methods such as a method of further stacking another chip on a chip, a method of arranging a plurality of chips in parallel on a substrate or a package (on a plane), and a method of combining the stacking and the parallel arrangement.

Since thermal expansion coefficients (also referred to as linear expansion coefficients) between chips, and of an interface of a substrate or a package are different, stress is generated due to heat generation by a chip operation, and a shape change (such as distortion) is generated. As a result, a characteristic of an active element in each of the chips varies, and chip performance also changes. When a MOSFET is described as an example of the active element, a threshold voltage Vth, carrier mobility μ, and the like may vary. The threshold voltage Vth and the carrier mobility μ are important parameters that determine a saturation current of the MOSFET, and variations thereof greatly influences the chip performance. Reflecting the influence of the stress generated due to the heat generation by the chip operation in the circuit simulation is useful for improving simulation accuracy, and the like.

### 1. Embodiment

### <Model Preparation>

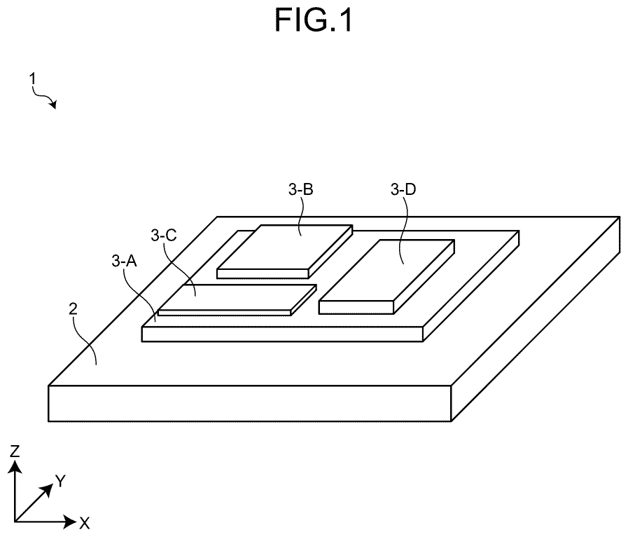

One of disclosed technologies is a simulation method. In the simulation method according to the embodiment, first, a model (simulation model) including a plurality of collectively arranged chips is prepared. Description will be made with reference to FIG. 1.

FIG. 1 is a view illustrating an example of the model. A model 1 includes a support 2 and a plurality of chips 3. An example of the support 2 is one substrate or one package. Each of the chips 3 is a semiconductor chip including an active element. An example of the active element is a field effect transistor (FET), more specifically, a metal-oxide-semiconductor (MOS) FET. The active element is assumed to be the MOSFET in the following unless otherwise specified.

The plurality of chips 3 is collectively arranged. Four chips 3 are illustrated as an example in FIG. 1. The chips 3 are referred to and illustrated as a chip 3-A, a chip 3-B, a chip 3-C, and a chip 3-D in such a manner as to be distinguishable.

At least a part of the plurality of chips 3 may be stacked on each other. At least a part of the plurality of chips 3 may be provided directly on the support 2 or via another chip 3. In the example illustrated in FIG. 1, the chip 3-A and the chip 3-B are stacked on each other. The chip 3-A and the chip 3-C are also stacked on each other. The chip 3-A and the chip 3-D are also stacked on each other. The chip 3-A is directly provided on the support 2. The chip 3-B, the chip 3-C, and the chip 3-D are provided on the chip 3-A.

Note that an XYZ coordinate system is also illustrated in FIG. 1. An X-axis direction and a Y-axis direction (XY plane direction) correspond to a plane direction of the support 2 and the chips 3. A Z-axis direction corresponds to a thickness direction of the support 2 and the chips 3, and corresponds to a stacking direction of the chips 3. The support 2 and the chips 3 are provided in this order in a Z-axis positive direction.

### <Heat Distribution Simulation>

Then, an in-chip heat distribution of each of the plurality of chips 3 is simulated in consideration of power consumption during an operation of the plurality of chips 3. Specifically, the power consumption of the operating chips 3 is given and a thermal analysis is performed, whereby a heat distribution is acquired. Various known thermal analysis technologies including a commercially available heat distribution simulator and the like may be used.

Since the power consumption has a strength distribution in a plane of each of the chips 3, the power consumption of the chip 3 may be given in such a manner that this distribution is accurately reflected. However, average power may be given uniformly to a size of the chip. As the power consumption, a power consumption distribution acquired by the operation of the chip may be used, or a power distribution converted from a heat distribution in the chip plane which heat distribution is acquired by actual measurement (thermography or thermocouple) or the like may be used.

The thermal analysis is performed with a material that joins the support 2 and each of the plurality of chips 3 (including a space between the chips 3), or the like being included. A physical property value in the thermal analysis is set in such a manner that the physical property value of each of the materials is appropriately reflected. Examples of the physical property value are thermal conductivity, thermal emissivity, and the like. In the thermal analysis, an appropriate heat transfer coefficient considering a surrounding situation may also be used. For example, in a case where the chips 3 are exposed to air, a heat transfer coefficient between the chips 3 and the air which coefficient corresponds to the situation is used.

The thermal analysis may be a steady state analysis or a non-steady state analysis. It can be said that the heat distribution simulation in a case of the non-steady state analysis includes a simulation of a temporal change of the heat distribution. Even in a complicated case where operation timing of the plurality of chips 3 is different, the heat distribution thereof can be accurately grasped.

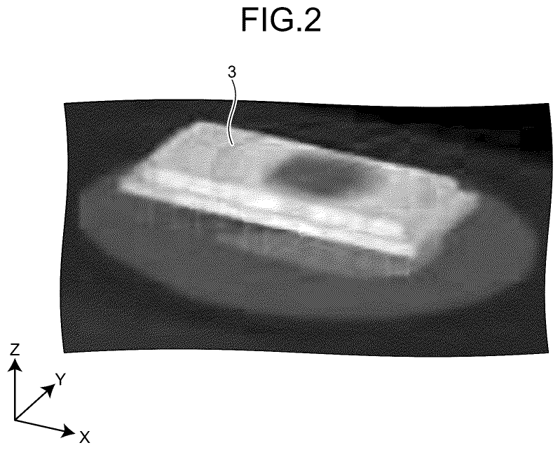

FIG. 2 is a view schematically illustrating an example of a heat distribution simulation result. The heat distribution in the chip 3 is illustrated in a gray scale. For example, such a heat distribution is acquired by a heat distribution simulation based on the model 1.

### <Stress Distribution Simulation>

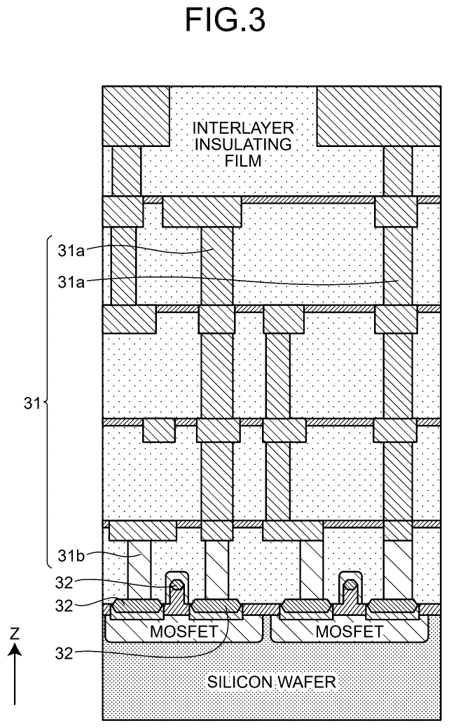

On the basis of the result of the heat distribution simulation, an in-chip stress distribution of each of the plurality of chips 3 is simulated. That is, the stress generated in each of the chips 3 due to the heat generation by the operation of the plurality of chips 3 is analyzed. The stress may be stress on a silicon surface of an active layer portion in which the MOSFET is configured. An example of a chip structure will be described with reference to FIG. 3.

FIG. 3 is a view illustrating the example of the chip structure. For example, as illustrated in FIG. 3, materials such as an insulating film (interlayer insulating film in this example), metal 31 (wiring metal 31a or metal 31b for contact with a wiring line in this example), a metal silicide 32, and silicon (silicon wafer in this example) that forms the MOSFET are present in the each of the chips 3. A stress distribution in consideration of the above is acquired in the plane direction (XY plane direction) and the height direction (Z-axis direction) of the chip 3. Various known stress analysis technologies including a commercially available stress distribution simulator and the like may be used.

A stress analysis is performed with a material that joins the support 2 and each of the plurality of chips 3, or the like being included. A physical property value in the stress analysis is set in such a manner that the physical property value of each of the materials is appropriately reflected. Examples of the physical property value include a thermal expansion coefficient, Young's modulus, Poisson's ratio, and an elastic modulus. Various kinds of force such as tensile force, compressive force, shearing force, bending force, and torsional force may be considered as the stress. Plastic deformation and elastic deformation may also be considered. A fatigue life (the number of repetitions) and repeated stress required for the plastic deformation may also be considered.

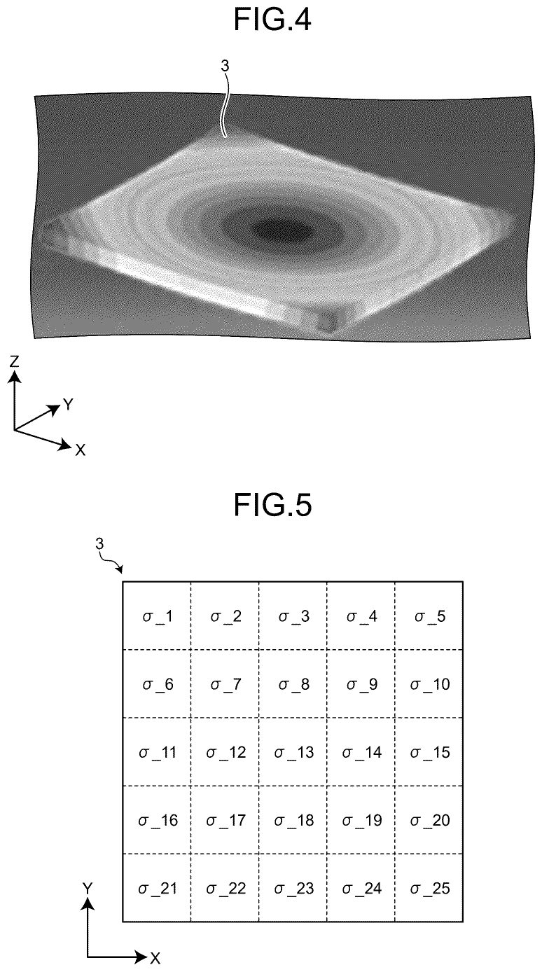

FIG. 4 is a view illustrating an example of a stress distribution simulation result. The stress distribution in the chip 3 is illustrated in a gray scale. For example, such a stress distribution is acquired by the stress distribution simulation based on the model 1.

In a case where the previous thermal analysis is the steady state analysis, the stress analysis may also be the steady state analysis. In a case where the previous thermal analysis is the non-steady state analysis, the stress analysis may also be the non-steady state analysis. It can be said that the stress distribution simulation in a case of the non-steady state analysis includes a simulation of a temporal change of the stress distribution.

For example, the materials such as the insulating film, the metal 31, the metal silicide 32, and silicon forming the MOSFET in the chip 3 in a manner described above with reference to FIG. 3 are manufactured by combination of the materials having the different thermal expansion coefficients by high-temperature heat treatment or the like in a semiconductor manufacturing process. Thus, when the chip 3 is manufactured, even when the chip 3 is in a non-operating state, residual stress is present in each of the materials. In one embodiment, an in-chip stress distribution may be simulated on the basis of the residual stress of each of the materials of when the chip 3 is manufactured. That is, the in-chip stress distribution of each of the plurality of chips 3 may be simulated with a state in which the residual stress of each of the materials is taken into consideration as a starting point on the basis of the heat distribution simulation result as described above. For example, the stress on the silicon surface due to the heat generation is determined from a state in which the residual stress of the various materials is present. It becomes possible to perform the stress distribution simulation in consideration of the residual stress of each of the materials.

### <Association of a Stress Distribution With In-Chip Coordinates and Instances>

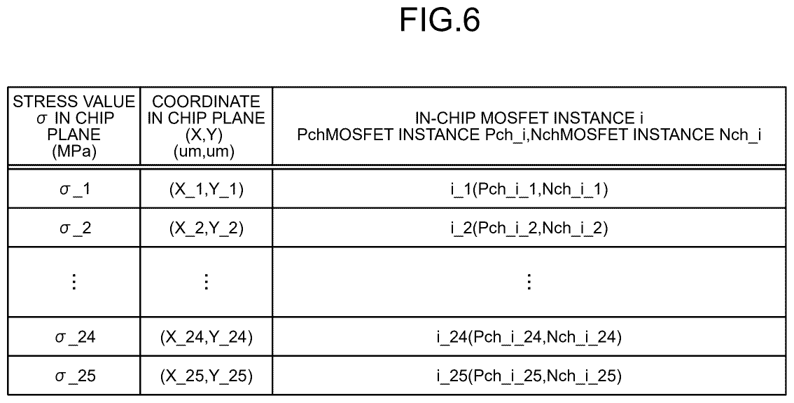

On the basis of the stress distribution simulation result, the stress distribution is associated (linked) with coordinates in the chip 3 and further with instances. Description will be made with reference to FIG. 5 to FIG. 6.

FIG. 5 and FIG. 6 are views illustrating an example of stress distribution association. As illustrated in FIG. 5, a stress value of each segment in one chip 3 is acquired from the previous stress distribution simulation result. Note that the stress value is also referred to as a stress value σ. The segment may correspond to a portion where the MOSFET is present in the chip 3. 25 segments in the chip 3 in the plane direction (XY plane) of the chip 3 are illustrated in FIG. 5. The stress values σ of the segments are respectively referred to and illustrated as a stress value σ_1 to a stress value σ_25 in the drawing.

As illustrated in FIG. 6, the stress values σ in the chip plane are associated with the coordinates in the chip plane. The coordinates in the chip plane are referred to as in-plane coordinates (X, Y). The in-plane coordinates (X, Y) corresponding to the 25 segments in the chip 3 are referred to and illustrated as in-plane coordinates (X_1, Y_1) to in-plane coordinates (X_25, Y_25). For example, the stress value σ_1 is associated with the in-plane coordinates (X_1, Y_1) and indicates the stress value of the segment at the in-plane coordinates (X_1, Y_1). The stress value σ_25 is associated with the in-plane coordinates (X_25, Y_25) and indicates the stress value of the segment at the in-plane coordinates (X_25, Y_25).

In the model 1 of FIG. 1 described above, the in-plane coordinates (X, Y) may be set with an arbitrary point of the support 2 as the origin, or may be set with an arbitrary point (such as a center point) of each of the chips 3 as the origin. In the latter case, information indicating which chip 3 among the plurality of chips 3 has the in-plane coordinates (X, Y) may also be given. A user may arbitrarily set a distance to an adjacent segment, such as a difference (ΔX) between X_1 and X_2, a difference (ΔY) between Y_1 and Y_2, and the like.

In addition, as further illustrated in FIG. 6, the stress values σ are also associated with MOSFET instances i in the chip 3. The MOSFET instances i correspond to instance names of the MOSFET in the circuit simulation described later. The MOSFET instances i corresponding to the in-plane coordinates (X_1, Y_1) to the in-plane coordinates (X_25, Y_25) are referred to as a MOSFET instance i_1 to a MOSFET instance i_25 in the drawing. For example, the stress value σ_1 corresponding to the in-plane coordinates (X_1, Y_1) is associated with the MOSFET instance i_1 and indicates a value of the stress applied to the MOSFET instance i_1. The stress value σ_25 corresponding to the in-plane coordinates (X_25, Y_25) is associated with the MOSFET instance i_25 and indicates a value of the stress applied to the MOSFET instance i_25.

More specifically, in this example, each of the MOSFET instances i includes a P-channel (Pch) MOSFET instance Pch_i and an N-channel (Nch) MOSFET instance Nch_i. Although a case where each of the MOSFET instances i includes one PchMOSFET instance Pch_i and one NchMOSFET instance Nch_i is illustrated in FIG. 6, a larger number of PchMOSFET instances Pch_i and NchMOSFET instances Nch_i may be included.

Data such as a netlist and a graphic date system (GDS) may be used to associate the stress values σ, the coordinates in the chip plane (X, Y), and the MOSFET instances i as illustrated in FIG. 6. For example, σ in the chip plane is associated with the coordinates in the chip plane (X, Y) on the basis of the data of the GDS. On the basis of the data of the netlist, the coordinates in the chip plane (X, Y) are associated with the MOSFET instances i, and the stress values σ are associated with the MOSFET instances i.

### <Association of a Heat Distribution With In-Chip Coordinates and Instances>

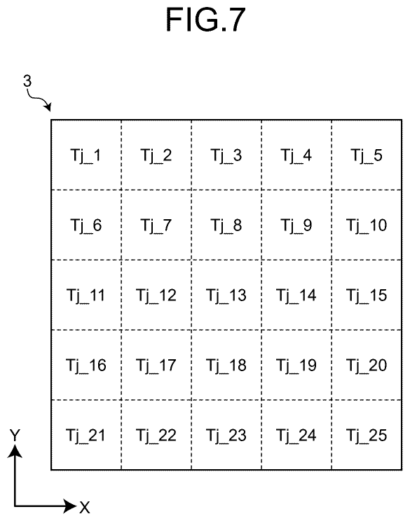

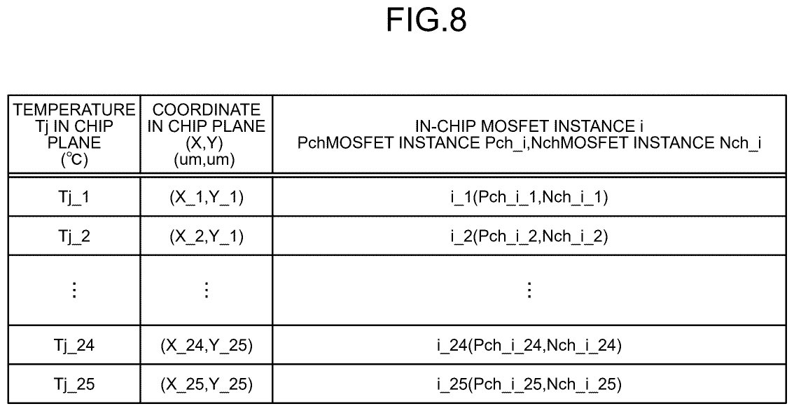

In addition, on the basis of the previous heat distribution simulation result, the heat distribution is associated with the coordinates in the chip 3 and further with the instance. Description will be made with reference to FIG. 7 and FIG. 8.

FIG. 7 and FIG. 8 are views illustrating an example of stress distribution association. As illustrated in FIG. 7, a temperature of each segment in one chip 3 is acquired from the previous heat distribution simulation result. Note that the temperature is also referred to as a temperature Tj. The temperatures Tj of the segments are referred to and illustrated as a temperature Tj_1 to a temperature Tj_25 in the drawing.

As illustrated in FIG. 8, the temperature Tj in the chip plane is associated with the in-plane coordinates (X, Y) of the chip 3. For example, the temperature Tj_1 is associated with the in-plane coordinates (X_1, Y_1) and indicates a temperature of the segment at the in-plane coordinates (X_1, Y_1). The temperature Tj_25 is associated with the in-plane coordinates (X_25, Y_25) and indicates a temperature of the segment at the in-plane coordinates (X_25, Y_25).

In addition, as further illustrated in FIG. 8, the temperature Tj is also associated with the MOSFET instances i in the chip 3. For example, the temperature Tj_1 corresponding to the in-plane coordinates (X_1, Y_1) is associated with the MOSFET instance i_1 and indicates a temperature of the MOSFET instance i_1. The temperature Tj_25 corresponding to the in-plane coordinates (X_25, Y_25) is associated with the MOSFET instance i_25 and indicates a temperature of the MOSFET instance i_25.

The data such as the netlist and the graphic date system (GDS) may also be used to associate the temperature Tj, the coordinates in the chip plane (X, Y), and the MOSFET instances i as illustrated in FIG. 8.

### <Calculation of a Characteristic Variation of an Active Element>

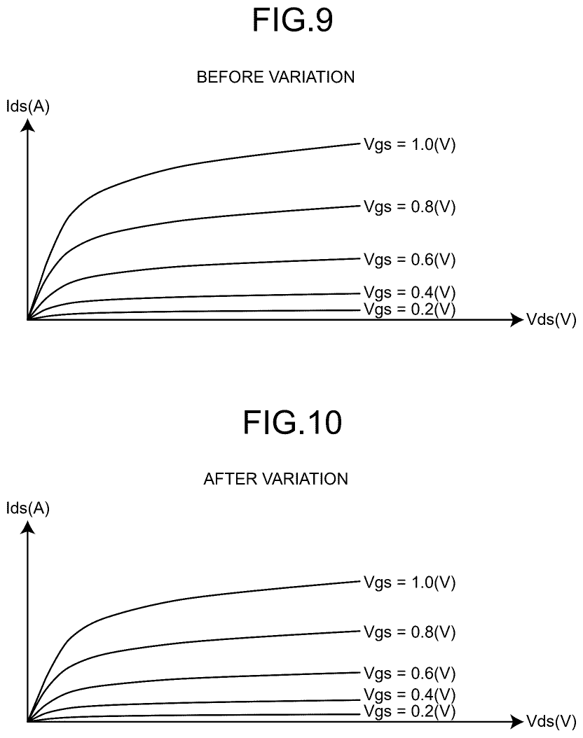

A characteristic variation of the MOSFET in the chip 3 is calculated on the basis of the stress distribution simulation result and also on the basis of the temperature distribution simulation result. Since the stress values σ and the temperature Tj are associated with the coordinates in the chip plane (X, Y) and the MOSFET instances i as described above, the characteristic variation of the MOSFET located at the same coordinates (in the same segment) is calculated on the basis of the stress value σ and the temperature Tj at each coordinate in the chip 3. Some examples of the characteristic variation will be described with reference to FIG. 9 to FIG. 12.

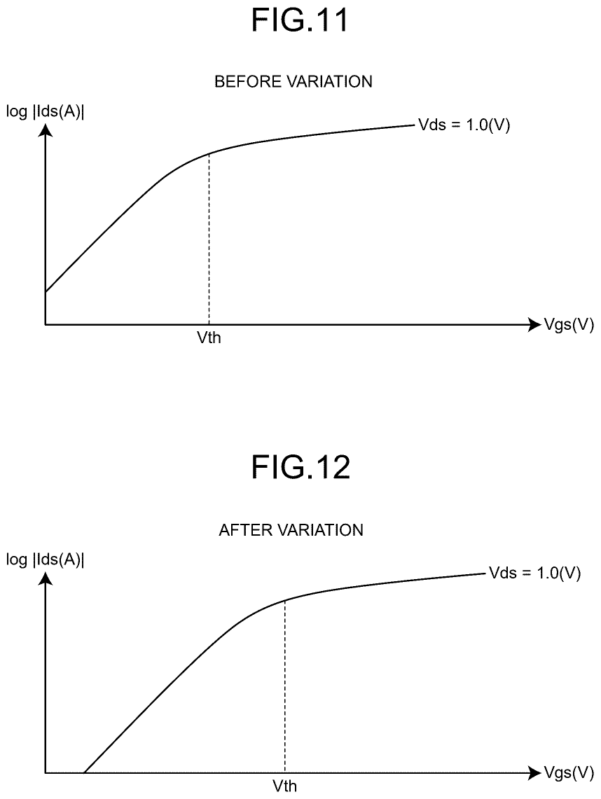

FIG. 9 to FIG. 12 are views illustrating the examples of the characteristic variation of the MOSFET. An Ids-Vds drain characteristic is illustrated as an example in FIG. 9 and FIG. 10. A characteristic before the variation is schematically illustrated in FIG. 9. A characteristic after the variation is schematically illustrated in FIG. 10. An Ids-Vgs subthreshold characteristic is illustrated as an example in FIG. 11 and FIG. 12. A characteristic before the variation is schematically illustrated in FIG. 11. A characteristic after the variation is schematically illustrated in FIG. 12.

The characteristic variation of the Ids-Vds drain characteristic, the Ids-Vgs subthreshold characteristic, and the like can correspond to a variation of a parameter related to an electric characteristic of the MOSFET. Examples of such a parameter are a threshold voltage Vth, carrier mobility μ, and the like. The threshold voltage Vth and the carrier mobility μ are important parameters that determine a current value of the MOSFET. This is because the saturation current Ids of the MOSFET is expressed as follows.

Ids=β(Vgs−Vth)²

β∝(½)×Cox×μ×(W/L)

Note that W is an active layer width of the MOSFET. L is a gate length of the MOSFET. Cox is gate capacitance (oxide film capacitance) of the MOSFET.

In order to make it possible to calculate the characteristic variation of the MOSFET from the stress values and the temperature, a relationship therebetween may be grasped in advance. For example, a characteristic variation amount of the MOSFET due to a change in the stress value and the temperature may be confirmed in advance by calculation or the like. Measured data may be used, or various known device simulations may be used.

In actual measurement, for example, by utilization of a MOSFET in which a gate, a drain, a source, and a substrate terminal are prepared in advance, stress, temperature, and the like are intentionally applied from the outside, voltage is applied between terminals for each stress value and temperature, and a characteristic variation of the MOSFET is measured. Although force and the temperature are applied from the outside, by estimating how much stress value or temperature is generated in which segment in the chip 3 in advance by a simulator, calculation, or the like, it is possible to acquire an accurate stress value or temperature generated in a MOSFET in an actual chip 3 and to perform efficient measurement.

For the device simulation, for example, a 3D device simulator capable of estimating an electric field distribution variation in a portion related to the electrical characteristic due to an influence of stress or heat generated inside the MOSFET may be used. An example of such a simulator is Technology Computer-Aided Design (TCAD).

Any tool that can perform necessary calculation may be used. The tool may be a general-purpose tool such as spreadsheet software.

### <Calculation of the Characteristic Variation in Consideration of a Size and Peripheral Structure of the Active Element>

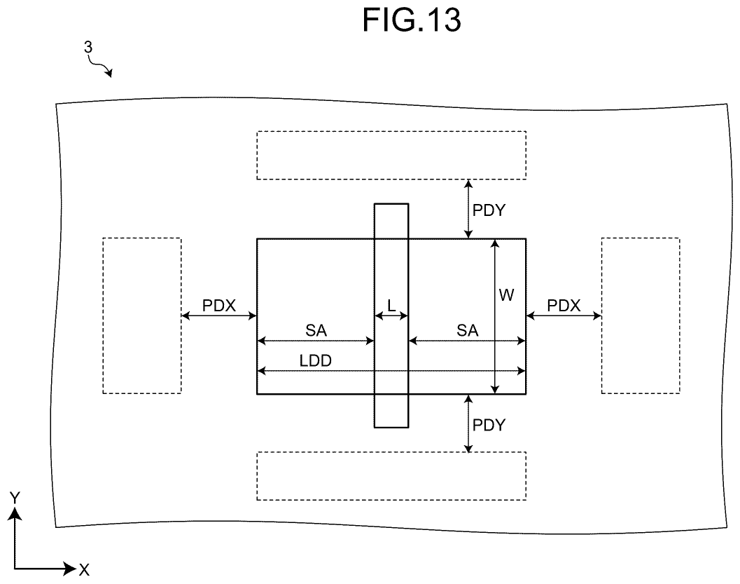

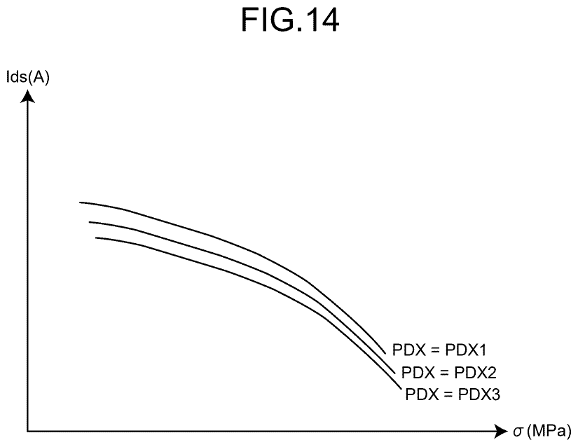

The size and peripheral structure of the MOSFET may influence the characteristic variation of the MOSFET due to stress. In an embodiment, the calculation of the characteristic variation of the MOSFET may also be performed on the basis of the size and the peripheral structure of the MOSFET in the chip 3 including the MOSFET. Description will be made with reference to FIG. 13 and FIG. 14.

FIG. 13 is a view illustrating an example of the size and peripheral structure of the active element. A planar layout of the MOSFET in the chip 3 is schematically illustrated. Arrows in the drawing are as follows.
W: active layer width of the MOSFET
L: gate length of the MOSFET
LDD: active layer length of the MOSFET
SA: length from a gate end of the MOSFET to an element isolation insulator
PDX: distance between active layers of the MOSFET in the X-axis direction
PDY: distance between active layers of the MOSFET in the Y-axis direction

With the characteristic after the variation in FIG. 10 or FIG. 12 described above as a basic characteristic, the characteristic variation of the MOSFET may be further calculated (adjusted) according to the size and peripheral structure of the MOSFET illustrated in FIG. 13. For example, by using at least one of W, L, LDD, SA, PDX, or PDY as a variable and incorporating the variable with the basic characteristic, it is possible to reflect the influence of the size and the peripheral structure of the MOSFET in the characteristic variation of the MOSFET. For example, a fitting parameter may be used to incorporate the variable into the basic characteristic. Description will be made also with reference to FIG. 14.

FIG. 14 is a view illustrating an example of the fitting parameter. In this example, by using PDX as the variable, a value of the saturation current Ids with respect to the stress value σ is changed by PDX. In the drawing, Ids of three cases in which PDX is PDX1 to PDX3 is illustrated. The saturation current Ids is expressed as follows with fitting parameters A to D, for example.

Ids=(A×σ^{B})×(C×ln(PDX)+D)

The fitting parameters A to D may be calculated on the basis of the characteristic variation grasped by actual changing of PDX in FIG. 10 or FIG. 12 described above. The same applies to W, L, LDD, SA, and PDY.

According to such a method, it is possible to appropriately calculate the characteristic variation of the MOSFET even in a case where there are various variations in the size and peripheral structure of the MOSFET. Note that the characteristic variation of the MOSFET which variation is calculated in consideration of the size and peripheral structure of the MOSFET is also referred to as a stress variation MOSFET characteristic value.

Note that a method not using the fitting parameter is also possible. For example, a large number of pieces of characteristic data (such as a lookup table) corresponding to various sizes and peripheral structures of the MOSFET may be prepared, and the data may be referred to.

### <Reflection in Circuit Simulation>

The previous heat distribution simulation result and stress distribution simulation result are reflected in the circuit simulation of each of the plurality of chips 3. The reflection is performed, for example, by an adjustment of a parameter in the circuit simulation. An example of the circuit simulation is a Spice simulation or the like, and description will be made in the following on the assumption that the circuit simulation is the Spice simulation.

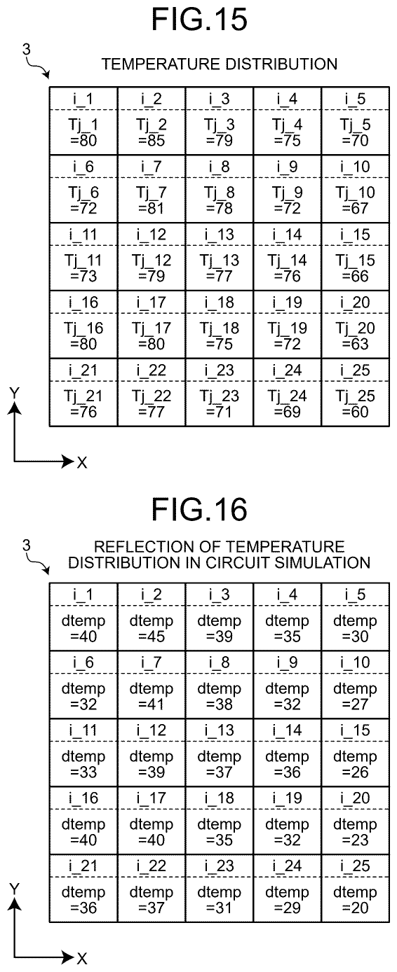

FIG. 15 and FIG. 16 are views illustrating an example of reflecting the temperature distribution simulation result in the circuit simulation. As illustrated in FIG. 15, the temperature Tj of the MOSFET instance i at each coordinate (in each segment) in the chip plane of the chip 3 is already known. Numerical values of the temperature Tj_1 to the temperature Tj_25 in the drawing are examples. A parameter in a Spice netlist is adjusted on the basis of the temperature information (the temperature information is fed back to the parameter).

Specifically, a parameter describing a temperature in the Spice simulation is adjusted. Examples of such a parameter are temp, dtemp, and the like. temp is a parameter indicating a temperature of the entire chip 3. dtemp is a parameter used to correct a temperature of each of the MOSFET instances i in the chip 3.

A case where the parameter temp corresponding to the temperature of the entire chip is set to 40 will be described as an example with reference to FIG. 16. A difference ΔTx between the value 40 of temp and the temperature Tj of each of the MOSFET instances i (FIG. 15) is set to dtemp of each of the MOSFET instances i in the Spice netlist. As a result, the temperature distribution is reflected in the MOSFET instances i in Spice.

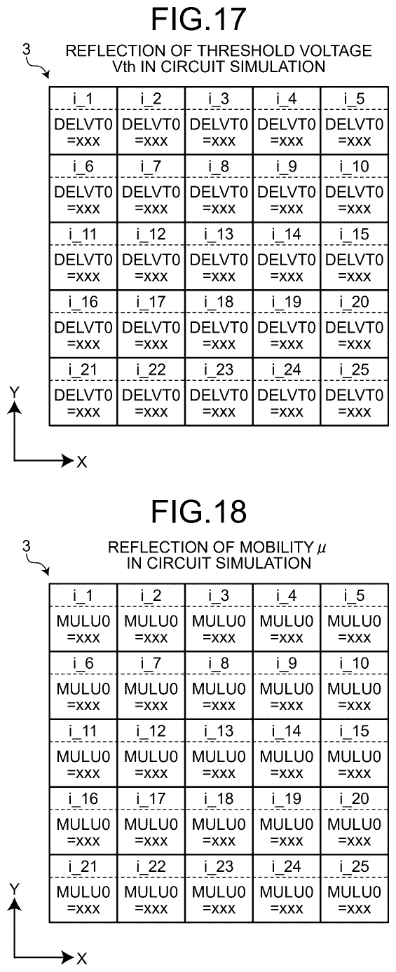

FIG. 17 and FIG. 18 are views illustrating an example of reflecting the stress distribution simulation result in the circuit simulation. More specifically, the characteristic variation of the MOSFET which variation is calculated on the basis of the stress distribution simulation result is reflected in the circuit simulation of the chip 3 including the MOSFET. As described above, the stress value σ of the MOSFET instance i at each coordinate in the chip plane of the chip 3 is already known, and the characteristic variation of the MOSFET at each coordinate based thereon is also calculated. A parameter in the Spice netlist is adjusted (the characteristic variation is fed back to the parameter) on the basis of the characteristic variation information.

Specifically, a parameter describing the characteristic of the MOSFET in the Spice simulation is adjusted (set or corrected, for example). More specifically, a parameter describing the threshold voltage Vth of the MOSFET, a parameter describing the carrier mobility μ of the MOSFET, or the like is adjusted. Examples of such parameters are DELVT0, MULU0, and the like. DELVT0 is a parameter used to correct the threshold voltage Vth of the MOSFET. MULU0 is a parameter used to correct the carrier mobility μ of the MOSFET.

A difference between the threshold voltage Vth of a case where there is no stress caused by the heat generation by the chip operation and the threshold voltage Vth of a case where there is the stress caused by the heat generation by the chip operation is denoted by ΔVth. Similarly, a difference in the carrier mobility μ is denoted by Δμ. A value to correct the threshold voltage Vth by ΔVth is set to DELVT0 in the Spice netlist. A value to correct the carrier mobility μ by Δμ is set to MULU0 in the Spice netlist. Note that a parameter corresponding to both the PchMOSFET and the NchMOSFET may be used. In addition, the values of DELVT0 and MULU0 set here may be determined by utilization of the stress variation MOSFET characteristic values described above.

As illustrated in FIG. 17, DELVT0 is set for each of the MOSFET instances i. Although being schematically expressed as “xxx”, the values of DELVT0 may be different. In addition, as illustrated in FIG. 18, MULU0 is set for each of the MOSFET instances i. Although being schematically expressed as “xxx”, the values of MULU0 may be different.

An input of the parameters such as temp, dtemp, DELVT0, and MULU0 described above may be performed automatically or may be performed by user operation (manually). For example, in a case where the characteristic of the MOSFET is varied only in a local portion, manual input can be effective.

For example, by adjusting the parameters in the circuit simulation as described above, it is possible to reflect the influence of the stress generated due to the heat generation by the chip operation in the circuit simulation. A coupled analysis of heat, stress, and electricity (circuit) becomes possible.

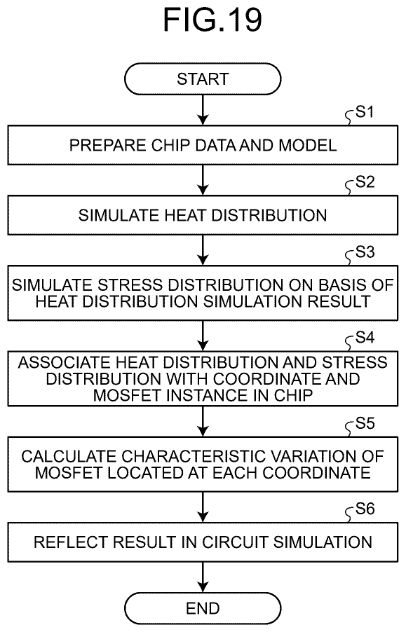

FIG. 19 is a flowchart illustrating an outline of the simulation method. Since the specific contents of each piece of processing has been described above, the description thereof will be omitted as appropriate.

In Step S1, chip data and a model are prepared. The chip data may include data of a netlist, data of a GDS, and the like of each of the plurality of chips 3. The model is, for example, the model 1 including the plurality of collectively arranged chips 3 and the support 2 as described above with reference to FIG. 1.

In Step S2, the in-chip heat distribution of each of the plurality of collectively arranged chips 3 during the operation of the chips 3 is simulated.

On the basis of the heat distribution simulation result, the in-chip stress distribution of each of the plurality of chips 3 is simulated in Step S3.

In Step S4, the heat distribution and the stress distribution are associated with the coordinates and the MOSFET instances i in the chip 3.

In Step S5, the characteristic variation of the MOSFET located at each coordinate (in each segment) is calculated.

In Step S6, a result is reflected in the circuit simulation of each of the plurality of chips 3. Here, the result is the heat distribution simulation result, the stress distribution simulation result, a result of the calculation of the characteristic variation of the MOSFET, or the like. The reflection is an adjustment of a parameter in the circuit simulation, for example.

### 2. Modification Example

The disclosed technology is not limited to the above embodiment. Some modification examples will be described.

An arrangement of a plurality of chips 3 is not limited to the example of FIG. 1 described above. Description will be made with reference to FIG. 20 to FIG. 22.

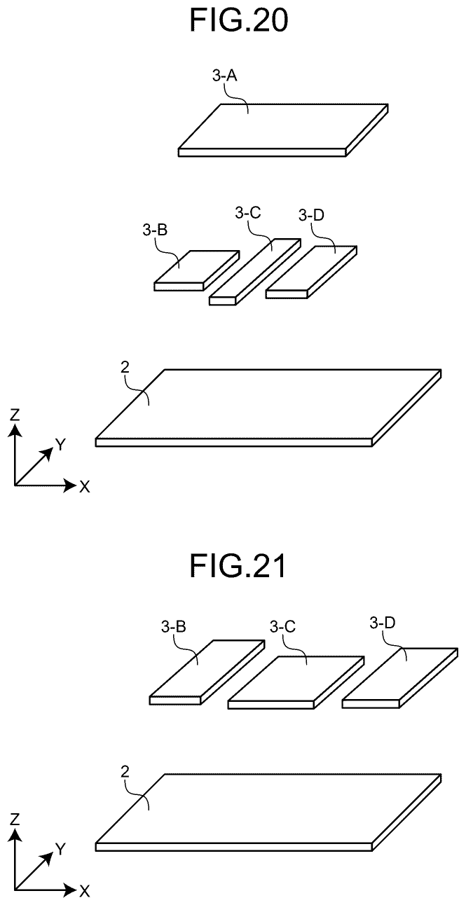

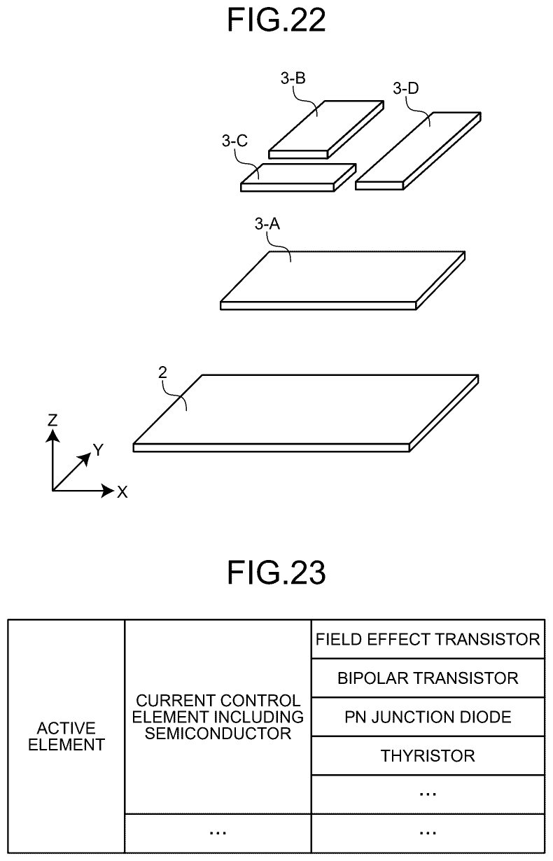

FIG. 20 to FIG. 22 are views illustrating examples of a chip arrangement. An exploded perspective view in which a support 2 and a plurality of chips 3 are exploded in a Z-axis direction is illustrated. In the example illustrated in FIG. 20, a chip 3-B, a chip 3-C, and a chip 3-C are mounted on the support 2 (in a first layer), and a chip 3-A is stacked thereon (in a second layer). In the example illustrated in FIG. 21, only a chip 3-B, a chip 3-C, and a chip 3-C are mounted on a support 2. In the example illustrated in FIG. 22, a chip 3-A is mounted on a support 2, and a chip 3-B, a chip 3-C, and a chip 3-D are stacked thereon. Shapes and directions of the chips 3 may vary.

In the above embodiment, a case where the active element included in each of the chips 3 is the MOSFET has been described as an example. However, the active element is not limited to the MOSFET. Description will be made with reference to FIG. 23.

FIG. 23 is a view illustrating an example of an active element. As the active element, a current control element including a semiconductor is illustrated as an example. Examples of such a current control element include a field effect transistor, a bipolar transistor, a PN junction diode, and a thyristor. The MOSFET described above is an example of a field effect transistor.

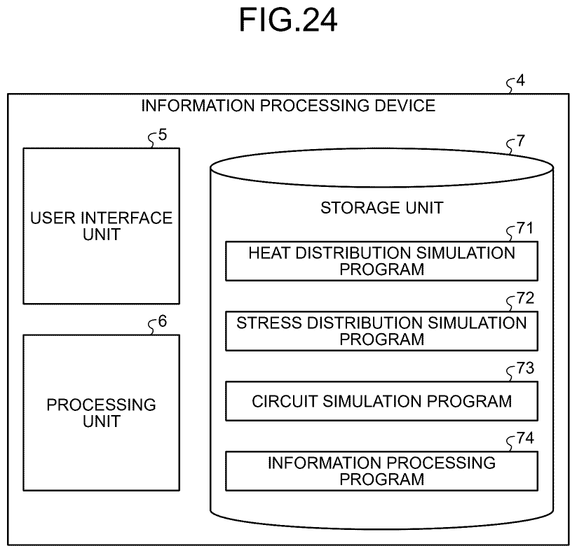

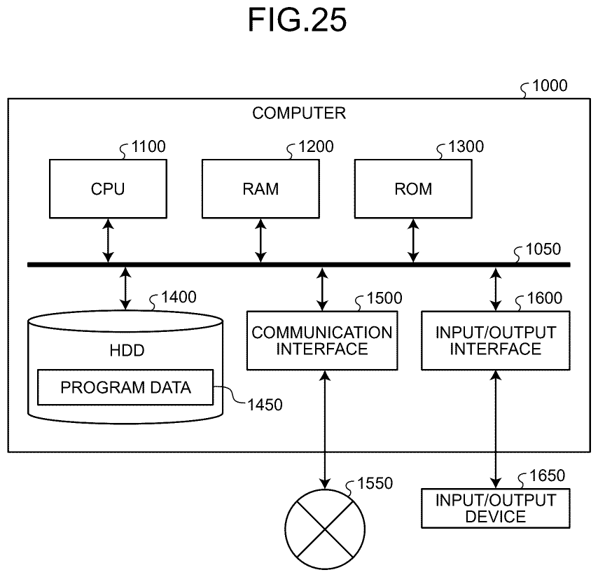

An information processing device and an information processing program that can be used for the simulation method according to the above embodiment may be provided. Description will be made with reference to FIG. 24 to FIG. 25.

FIG. 24 is a view illustrating an example of a schematic configuration of an information processing device. An information processing device 4 includes a user interface unit 5, a processing unit 6, and a storage unit 7. The user interface unit 5 receives user operation and presents information to a user. The processing unit 6 executes various kinds of preprocessing.

Examples of information stored in the storage unit 7 include a heat distribution simulation program 71, a stress distribution simulation program 72, a circuit simulation program 73, and an information processing program 74. The heat distribution simulation program 71, the stress distribution simulation program 72, and the circuit simulation program 73 are used to perform the heat distribution simulation, the stress distribution simulation, and the circuit simulation described above. The information processing program 74 is a program (software or application) for causing a computer to function as (the user interface unit 5, the processing unit 6, and the like of) the information processing device 4.

When the processing unit 6 executes the various kinds of processing in accordance with the user operation via the user interface unit 5, a procedure of the simulation method according to the embodiment described above can be advanced. The model 1 described above with reference to FIG. 1 and chip data of each of the chips 3 included therein are prepared. The heat distribution simulation program 71 is executed, and a heat distribution simulation result is acquired. The stress distribution simulation program 72 is executed on the basis of the heat distribution simulation result, and a stress distribution simulation result is acquired. On the basis of these simulation results, a characteristic variation of the MOSFET in the chip 3 is calculated. As described above, a separately prepared device simulator, an arbitrary tool, or the like may be used for this calculation. The simulation results and the calculation result are reflected in the circuit simulation, and the circuit simulation program 73 is executed.

Note that a part of functions of the information processing device 4 may be included in an external server device configured to be able to communicate with the information processing device 4. Examples of the functions that may be included in the external server device include a part of the function of the processing unit 6, a part or whole of the heat distribution simulation program 71, a part or whole of the stress distribution simulation program 72, a part or whole of the circuit simulation program 73, and the like.

FIG. 25 is a view illustrating a hardware configuration example of the information processing device. For example, the information processing device 4 can be realized by a computer 1000 in an illustrated manner. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of programs stored in the ROM 1300 or the HDD 1400, and controls each unit. For example, the CPU 1100 expands the programs, which are stored in the ROM 1300 or the HDD 1400, in the RAM 1200 and executes processing corresponding to the various programs. The programs include the heat distribution simulation program 71, the stress distribution simulation program 72, the circuit simulation program 73, the information processing program 74, and the like described above.

The ROM 1300 stores a boot program such as a basic input output system (BIOS) executed by the CPU 1100 during activation of the computer 1000, a program that depends on hardware of the computer 1000, and the like.

The HDD 1400 is a computer-readable recording medium that non-temporarily records the programs executed by the CPU 1100, data used by the programs, and the like. Specifically, the HDD 1400 is a recording medium that records the information processing program 74 or the like that is an example of the program data 1450.

The communication interface 1500 is an interface for the computer 1000 to connect to an external network 1550 (such as the Internet). For example, via the communication interface 1500, the CPU 1100 receives data from another device or transmits data generated by the CPU 1100 to another device.

The input/output interface 1600 is an interface to connect an input/output device 1650 and the computer 1000. For example, the CPU 1100 receives data from an input device such as a keyboard or mouse via the input/output interface 1600. Furthermore, the CPU 1100 transmits data to an output device such as a display, a speaker, or a printer via the input/output interface 1600. Furthermore, the input/output interface 1600 may function as a medium interface that reads a program or the like recorded on a predetermined recording medium (medium). The medium is, for example, an optical recording medium such as a digital versatile disc (DVD) or phase change rewritable disk (PD), a magneto-optical recording medium such as a magneto-optical disk (MO), a tape medium, a magnetic recording medium, a semiconductor memory, or the like.

For example, the CPU 1100 of the computer 1000 implements the functions of the information processing device 4 by executing the information processing program 74 loaded on the RAM 1200. Note that the CPU 1100 reads the program data 1450 from the HDD 1400 and performs execution thereof. However, these programs may be acquired from another device via the external network 1550 in another example.

### 3. Examples of Effects

The technology described above is specified as follows, for example. One of disclosed technologies is a simulation method. As described with reference to FIG. 1 to FIG. 19 and the like, the simulation method includes: simulating the in-chip heat distribution of each of the plurality of collectively arranged chips 3, each of which includes the active element (such as the current control element made of the semiconductor, such as the field effect transistor (including the MOSFET), the bipolar transistor, the PN junction diode, or the thyristor), in consideration of the power consumption during the operation of the plurality of chips 3 (Step S2); simulating the in-chip stress distribution of each of the plurality of chips 3 on the basis of the heat distribution simulation result (Step S3); and reflecting the stress distribution simulation result in the circuit simulation of each of the plurality of chips 3 (Step S6). As a result, the influence of the stress generated due to the heat generation by the chip operation can be reflected in the circuit simulation.

As described with reference to FIG. 9 to FIG. 14, FIG. 19, and the like, the simulation method may include calculating the characteristic variation of the active element on the basis of the stress distribution simulation result (Step S5), and reflecting in the circuit simulation (Step S6) may include reflecting the calculation result of the characteristic variation of the active element in the circuit simulation of the chip 3 including the active element. As a result, the characteristic variation of the active element which variation is caused by the stress can be reflected in the circuit simulation.

As described with reference to FIG. 5, FIG. 6, FIG. 9 to FIG. 14, FIG. 19, and the like, the simulation method may include associating the stress distribution with coordinates in the chip 3 including the active element (Step S4), and calculating the characteristic variation of the active element (Step S5) may include calculating the characteristic variation of the active element located at the same coordinates on the basis of the stress value σ at each coordinate in the chip 3. For example, in such a manner, the characteristic variation of the active element at each position in the chip 3 can be calculated.

As described with reference to FIG. 13, FIG. 14, FIG. 19, and the like, calculating the characteristic variation of the active element (Step S5) may include calculating the variation characteristic of the active element on the basis of the size and the peripheral structure of the active element in the chip 3 including the active element. As a result, even in a case where there are various variations in the size and peripheral structure of the active element, the characteristic variation of the active element can be appropriately calculated.

As described with reference to FIG. 3 and FIG. 19 and the like, the chip 3 is a chip manufactured by combination of the plurality of materials having the different thermal expansion coefficients, and simulating the stress distribution (Step S3) may include simulating the in-chip stress distribution on the basis of the residual stress of the plurality of materials of when the chip 3 is manufactured. As a result, it becomes possible to perform the stress distribution simulation in consideration of the residual stress of each material of the chip 3.

As described with reference to FIG. 9 to FIG. 12, FIG. 19, and the like, calculating the characteristic variation of the active element (Step S5) may include calculating the characteristic variation of the active element in the chip 3 also on the basis of the heat distribution simulation result. As a result, the characteristic variation of the active element which variation is caused by the heat generated by the operation of the chip 3 can also be reflected in the circuit simulation.

As described with reference to FIG. 1, FIG. 15 to FIG. 19, FIG. 23, and the like, reflecting in the circuit simulation (Step S6) may include adjusting the parameter that describes the characteristic of the active element in the circuit simulation. The active element may include the field effect transistor, and the parameter may include at least one of the parameter describing the carrier mobility μ or the parameter describing the threshold voltage Vth. For example, the circuit simulation may include the Spice simulation, the parameter describing the carrier mobility μ may include MULU0, and the parameter describing the threshold voltage Vth may include DELVT0. For example, the characteristic variation of the active element can be reflected in the circuit simulation by such parameter adjustment.

As described with reference to FIG. 15, FIG. 16, FIG. 19, and the like, the simulation method may include adjusting the parameter describing the temperature in the circuit simulation on the basis of the heat distribution simulation result. For example, the circuit simulation may include the Spice simulation, and the parameter describing the temperature may include dtemp. As a result, the temperature distribution can also be reflected in the circuit simulation.

As described with reference to FIG. 1 and FIG. 20 to FIG. 22 and the like, at least a part of the plurality of chips 3 may be stacked on each other. At least a part of the plurality of chips 3 may be directly provided on one substrate or package (support 2). For example, for the plurality of chips 3 collectively arranged in such various modes, the influence of the stress generated due to the heat generation by the chip operation can be reflected in the circuit simulation.

As described with reference to FIG. 1 to FIG. 4, FIG. 19, and the like, simulating the heat distribution (Step S2) may include the simulation of the temporal change of the heat distribution, and simulating the stress distribution (Step S3) may include the simulation of the temporal change of the stress distribution. As a result, for example, even in a complicated case where the operation timing of the plurality of chips 3 is different, the influence of the stress generated due to the heat generation by the chip operation can be reflected in the circuit simulation.

The information processing device 4 and the information processing program 74 described with reference to FIG. 1 to FIG. 19, FIG. 24, FIG. 25, and the like are also examples of the disclosed technologies. The information processing device 4 includes the processing unit 6 that simulates the in-chip heat distribution of each of the plurality of collectively arranged chips 3 in consideration of the power consumption during the operation of the plurality of chips 3, simulates the in-chip stress distribution of each of the plurality of chips 3 on the basis of the heat distribution simulation result, and reflects the stress distribution simulation result in the circuit simulation of each of the plurality of chips 3. The information processing program 74 causes the computer 1000 to execute processing of simulating the in-chip heat distribution of each of the plurality of collectively arranged chips 3 in consideration of the power consumption during the operation of the plurality of chips 3, simulating the in-chip stress distribution of each of the plurality of chips 3 on the basis of the heat distribution simulation result, and reflecting the stress distribution simulation result in the circuit simulation of each of the plurality of chips 3. As described above, the information processing device 4 and the information processing program 74 can also reflect the influence of the stress generated due to the heat generation by the chip operation in the circuit simulation.

Note that the effects described in the present disclosure are merely examples and are not limited to the disclosed contents. There may be other effects.

Although an embodiment of the present disclosure has been described above, the technical scope of the present disclosure is not limited to the above-described embodiment as it is, and various modifications can be made within the spirit and scope of the present disclosure. In addition, components of different embodiments and modification examples may be arbitrarily combined.

Note that the present technology can also have the following configurations.
(1) A simulation method comprising:
   simulating an in-chip heat distribution of each of a plurality of collectively arranged chips, each of which includes an active element, in consideration of power consumption during an operation of the plurality of chips;
   simulating an in-chip stress distribution of each of the plurality of chips on a basis of a heat distribution simulation result; and
   reflecting a stress distribution simulation result in a circuit simulation of each of the plurality of chips.
(2) The simulation method according to (1), further comprising
   calculating a characteristic variation of the active element on a basis of the stress distribution simulation result, wherein
   reflecting in the circuit simulation includes reflecting a calculation result of the characteristic variation of the active element in a circuit simulation of a chip including the active element.
(3) The simulation method according to (2), further comprising
   associating the stress distribution with coordinates in the chip including the active element, wherein
   calculating the characteristic variation of the active element includes calculating a characteristic variation of an active element located at same coordinates on a basis of a stress value at each coordinate in the chip.
(4) The simulation method according to (2) or (3), wherein
   calculating the characteristic variation of the active element includes calculating a variation characteristic of the active element on a basis of a size and a peripheral structure of the active element in the chip including the active element.
(5) The simulation method according to any one of (1) to (4), wherein
   the chip is a chip manufactured by combination of a plurality of materials having different thermal expansion coefficients, and
   simulating the stress distribution includes simulating the in-chip stress distribution on a basis of residual stress of the plurality of materials of when the chip is manufactured.
(6) The simulation method according to any one of (2) to (5), wherein
   calculating the characteristic variation of the active element includes calculating the characteristic variation of the active element in the chip also on a basis of the heat distribution simulation result.
(7) The simulation method according to any one of (1) to (6), wherein
   reflecting in the circuit simulation includes adjusting a parameter describing a characteristic of the active element in the circuit simulation.
(8) The simulation method according to (7), wherein
   the active element includes a field effect transistor, and
   the parameter includes at least one of a parameter describing a threshold voltage or a parameter describing carrier mobility.
(9) The simulation method according to (8), wherein
   the circuit simulation includes a Spice simulation,
   the parameter describing the carrier mobility includes MULU0, and
   the parameter describing the threshold voltage includes DELVT0.
(10) The simulation method according to any one of (1) to (9), further comprising
   adjusting a parameter describing a temperature in the circuit simulation on a basis of the heat distribution simulation result.
(11) The simulation method according to (10), wherein
   the circuit simulation includes a Spice simulation, and
   the parameter describing the temperature includes dtemp.
(12) The simulation method according to any one of (1) to (11), wherein
   at least a part of the plurality of chips is stacked on each other.
(13) The simulation method according to any one of (1) to (12), wherein
   at least a part of the plurality of chips is directly provided on one substrate or package.
(14) The simulation method according to any one of (1) to (13), wherein
   the active element includes a current control element including a semiconductor, and
   the current control element includes
   at least one of
   a field effect transistor,
   a bipolar transistor,
   a PN junction diode, or
   a thyristor.
(15) The simulation method according to any one of (1) to (14), wherein
   the active element includes a MOSFET.
(16) The simulation method according to any one of (1) to (15), wherein
   simulating the heat distribution includes a simulation of a temporal change of the heat distribution, and
   simulating the stress distribution includes a simulation of a temporal change of the stress distribution.
(17) An information processing device comprising:
   a processing unit that
   simulates an in-chip heat distribution of each of a plurality of collectively arranged chips in consideration of power consumption during an operation of the plurality of chips,
   simulates an in-chip stress distribution of each of the plurality of chips on a basis of a heat distribution simulation result, and
   reflects a stress distribution simulation result in a circuit simulation of each of the plurality of chips.
(18) An information processing program causing
   a computer to execute
   processing of:
   simulating an in-chip heat distribution of each of a plurality of collectively arranged chips in consideration of power consumption during an operation of the plurality of chips;
   simulating an in-chip stress distribution of each of the plurality of chips on a basis of a heat distribution simulation result; and
   reflecting a stress distribution simulation result in a circuit simulation of each of the plurality of chips.

### REFERENCE SIGNS LIST

1 MODEL
2 SUPPORT
3 CHIP
4 INFORMATION PROCESSING DEVICE
5 USER INTERFACE UNIT
6 PROCESSING UNIT
7 STORAGE UNIT
71 HEAT DISTRIBUTION SIMULATION PROGRAM
72 STRESS DISTRIBUTION SIMULATION PROGRAM
73 CIRCUIT SIMULATION PROGRAM
74 INFORMATION PROCESSING PROGRAM

1. A simulation method comprising:
simulating an in-chip heat distribution of each of a plurality of collectively arranged chips, each of which includes an active element, in consideration of power consumption during an operation of the plurality of chips;
simulating an in-chip stress distribution of each of the plurality of chips on a basis of a heat distribution simulation result; and
reflecting a stress distribution simulation result in a circuit simulation of each of the plurality of chips.

2. The simulation method according to claim 1, further comprising
calculating a characteristic variation of the active element on a basis of the stress distribution simulation result, wherein
reflecting in the circuit simulation includes reflecting a calculation result of the characteristic variation of the active element in a circuit simulation of a chip including the active element.

3. The simulation method according to claim 2, further comprising
associating the stress distribution with coordinates in the chip including the active element, wherein
calculating the characteristic variation of the active element includes calculating a characteristic variation of an active element located at same coordinates on a basis of a stress value at each coordinate in the chip.

4. The simulation method according to claim 2, wherein
calculating the characteristic variation of the active element includes calculating a variation characteristic of the active element on a basis of a size and a peripheral structure of the active element in the chip including the active element.

5. The simulation method according to claim 1, wherein
the chip is a chip manufactured by combination of a plurality of materials having different thermal expansion coefficients, and
simulating the stress distribution includes simulating the in-chip stress distribution on a basis of residual stress of the plurality of materials of when the chip is manufactured.

6. The simulation method according to claim 2, wherein
calculating the characteristic variation of the active element includes calculating the characteristic variation of the active element in the chip also on a basis of the heat distribution simulation result.

7. The simulation method according to claim 1, wherein
reflecting in the circuit simulation includes adjusting a parameter describing a characteristic of the active element in the circuit simulation.

8. The simulation method according to claim 7, wherein
the active element includes a field effect transistor, and
the parameter includes at least one of a parameter describing a threshold voltage or a parameter describing carrier mobility.

9. The simulation method according to claim 8, wherein
the circuit simulation includes a Spice simulation,
the parameter describing the carrier mobility includes MULU0, and
the parameter describing the threshold voltage includes DELVT0.

10. The simulation method according to claim 1, further comprising
adjusting a parameter describing a temperature in the circuit simulation on a basis of the heat distribution simulation result.

11. The simulation method according to claim 10, wherein
the circuit simulation includes a Spice simulation, and
the parameter describing the temperature includes dtemp.

12. The simulation method according to claim 1, wherein
at least a part of the plurality of chips is stacked on each other.

13. The simulation method according to claim 1, wherein
at least a part of the plurality of chips is directly provided on one substrate or package.

14. The simulation method according to claim 1, wherein
the active element includes a current control element including a semiconductor, and
the current control element includes
at least one of
a field effect transistor,
a bipolar transistor,
a PN junction diode, or
a thyristor.

15. The simulation method according to claim 1, wherein
the active element includes a MOSFET.

16. The simulation method according to claim 1, wherein
simulating the heat distribution includes a simulation of a temporal change of the heat distribution, and
simulating the stress distribution includes a simulation of a temporal change of the stress distribution.

17. An information processing device comprising:
a processing unit that
simulates an in-chip heat distribution of each of a plurality of collectively arranged chips in consideration of power consumption during an operation of the plurality of chips,
simulates an in-chip stress distribution of each of the plurality of chips on a basis of a heat distribution simulation result, and
reflects a stress distribution simulation result in a circuit simulation of each of the plurality of chips.

18. An information processing program causing
a computer to execute
processing of:
simulating an in-chip heat distribution of each of a plurality of collectively arranged chips in consideration of power consumption during an operation of the plurality of chips;
simulating an in-chip stress distribution of each of the plurality of chips on a basis of a heat distribution simulation result; and
reflecting a stress distribution simulation result in a circuit simulation of each of the plurality of chips.
